(19) United States
(12) Patent Application Publication
(10) Pub. No.: US 2026/0251248 A1
(43) Pub. Date: Aug. 27, 2026

(54) ADAPTER COUPLING

(71) Applicant: VICTAULIC COMPANY, Easton, PA (US)

(72) Inventors: Richard Marakovits, Bethlehem, PA (US); Matthew A. Bowman, Palmer, PA (US); Michael R. Novitsky, Slatington, PA (US); Alan M. Yesavage, Lenhartsville, PA (US); Scott D. Madara, Nazareth, PA (US)

(21) Appl. No.: 19/546,328

(22) Filed: Feb. 21, 2026

Related U.S. Application Data
(60) Provisional application No. 63/761,779, filed on Feb. 21, 2025.
(60) Provisional application No. 63/761,629, filed on Feb. 21, 2025.

(51) Int. Cl. F16L 23/08; F16L 23/22

(52) U.S. Cl. CPC F16L 23/08; F16L 23/22

(57) ABSTRACT

An adapter coupling for joining a flanged pipe element to a grooved pipe element comprises a plurality of segments attached to one another end to end surrounding a central space. Each segment comprises a flange body, a channel, a gasket positioned in the channel, a key extending toward the central space, and adjustable attachment members for attaching the segments to one another. The key comprises a tip surface and first and second keywalls inclined towards one another. The adapter coupling may be provided in a preassembled state with the gasket supporting the segments in spaced apart relation. A grooved pipe element having a groove with sidewalls oriented at obtuse angles relative to a floor surface is inserted into the central space. As the adjustable attachment members are adjusted, the keywalls engage the groove sidewalls and wedge into the groove, promoting a firm connection and increased joint rigidity.

### CROSS REFERENCE TO RELATED APPLICATIONS

This application is based upon and claims priority to U.S. Provisional Application No. 63/761,779, filed Feb. 21, 2025, and US Provisional Application No. 63/761,629, filed Feb. 21, 2025, which applications are hereby incorporated by reference in their entirety.

### FIELD

This disclosure relates to mechanical couplings for joining pipe elements end to end. For example, the disclosed mechanical couplings can join flanged pipe elements to non-flanged pipe elements.

### BACKGROUND

Connecting a non-flanged pipe element, such as a grooved pipe element, to a flanged pipe element, often requires the use of an adapter coupling comprising two or more housing segments which are drawn toward each other to engage the groove, a gasket, fasteners to draw the segments together, and fasteners to bolt the adapter coupling to the mating flanged pipe element. Unlike many couplings used to connect, for instance, grooved pipe elements to other grooved pipe elements and that are provided in a preassembled state in which the couplings may be slipped directly over the pipe elements to be joined and their fasteners tightened to complete the assembly, adapter couplings often comprise multiple pieces which have to be manually assembled about the pipe, affixed to one another, and then bolted to the mating flanged pipe element. Owing to the need to ensure that the bolt holes on the adapter coupling need to be located in an industry-standard pattern such that it can mate with an opposing flanged pipe element, the degree to which the adapter coupling can both grip the pipe within the groove on the grooved side and have its bolt holes in the industry standard pattern has often resulted in flange adapters which grip the pipe in a manner that reduces the rigidity of the connection, especially the torsional rigidity of the connection, relative to the flange connection.

When forming a connection with a pipe element, multiple parts, namely, the coupling housings, housing fasteners, and gasket need to be carefully assembled about the pipe element without damaging the gasket. In some cases, tools such as pliers are required to bring the coupling segments together adequately. Further, meeting the bolt pattern requirements while also gripping the pipe sufficiently to provide a firm joint may be challenging across the range of pipe, groove, and adapter tolerances in practical applications.

In view of the limitations and drawbacks of the above approaches, there is an opportunity to advantageously improve the process for joining non-flanged pipe elements to flanged pipe elements.

### SUMMARY

In one aspect, an example adapter coupling for joining a flanged pipe element to a grooved pipe element comprises a plurality of segments attached to one another end to end surrounding a central space. Each of the segments comprises a flange body having a pipe-facing side portion and a flange-facing side portion, a channel positioned within the flange body extending circumferentially therearound and facing the central space, a gasket positioned in the channel, a key positioned on the flange body extending toward the central space, and adjustable attachment members positioned at ends of the segments for attaching the segments to one another.

In another aspect, an example adapter coupling for joining a flanged pipe element to a grooved pipe element comprises a plurality of segments attached to one another end to end surrounding a central space and a longitudinal axis. Each of the segments comprises a flange body having a pipe-facing side portion and a flange-facing side portion, the flange body having facing surfaces at each end of the segments, a key positioned on the flange body extending toward the central space, and projections extending from the pipe-facing side portion at each end of the segments. The projections extend in a direction parallel or generally parallel to the longitudinal axis. Each of the projections comprises an opening configured to receive a fastener, the opening being positioned between the central space and an outermost surface of the flange body. The facing surfaces on respective ends of the segments are in facing relation with one another and are configured to be drawn toward one another as the fasteners are tightened.

In another aspect, a combination of an example adapter coupling and an example grooved pipe element is provided. The adapter coupling comprises a plurality of segments attached to one another end to end surrounding a central space. Each of the segments comprises a flange body having a pipe-facing side portion and a flange-facing side portion, a channel positioned within the flange body extending circumferentially therearound and facing the central space, a gasket positioned in the channel, a key positioned on the flange body extending toward the central space, and adjustable attachment members positioned at ends of the segments for attaching the segments to one another. The key comprises a radially inwardmost tip surface extending along the key, a first keywall extending from the flange body to the tip surface, and a second keywall extending from the flange body to the tip surface. The first keywall and the second keywall are inclined towards one another, with the first and second keywalls being closer together at the tip surface. The grooved pipe element comprises a sidewall surrounding a longitudinal axis and defining a bore, the sidewall having an outer surface, an endform, and a tubular portion connected to the endform. The endform extends from an end of the grooved pipe element to the tubular portion. The endform comprises a groove defined by the outer surface, the groove extending circumferentially around the bore. The groove comprises a first groove side surface, a second groove side surface facing the first groove side surface and in spaced apart relation from the first groove side surface along the longitudinal axis, and a floor surface contiguous with the first groove side surface and the second groove side surface. The first groove side surface is positioned between the end of the grooved pipe element and the second groove side surface. The keys are configured to engage with the groove such that the first keywall is configured to engage with the first groove side surface and the second keywall is configured to engage with the second groove side surface.

In another aspect, an example method of joining a flanged pipe element to a grooved pipe element using an adapter coupling is provided. The adapter coupling comprises a plurality of segments attached to one another end to end in a preassembled state surrounding a central space. Each of the segments comprises a flange body, a channel positioned within the flange body, a gasket positioned in the channel, a key positioned on the flange body extending toward the central space, and adjustable attachment members positioned at ends of the segments. The key comprises a tip surface, a first keywall, and a second keywall. The grooved pipe element comprises a sidewall having an outer surface and an endform comprising a groove defined by the outer surface. The groove comprises a first groove side surface, a second groove side surface, and a floor surface. The method comprises inserting the grooved pipe element into the central space of the adapter coupling in the preassembled state, adjusting the adjustable attachment members to draw the plurality of segments toward one another such that the first keywall engages the first groove side surface and the second keywall engages the second groove side surface, and joining the flanged pipe element to the adapter coupling by aligning holes in the flanged pipe element with flange holes in the segments and securing with fasteners.

### BRIEF DESCRIPTION OF THE DRAWINGS

FIG. 1 is an isometric view of an example adapter coupling according to the invention shown in the preassembled state;

FIG. 2 is a front view of an example adapter coupling according to the invention shown in a preassembled state;

FIG. 3 is a side view of an example adapter coupling;

FIG. 4 is a rear view of a first segment of the example adapter coupling shown in FIG. 2;

FIG. 5 is an underside view of the first segment of the example adapter coupling of FIG. 4;

FIG. 6 is a top plan view of a second segment of the example adapter coupling shown in FIG. 2;

FIG. 7 is a rear view of the second segment of the example adapter coupling shown in FIG. 6;

FIG. 8 is a side view of an example grooved pipe element;

FIG. 9 is a side view of a second embodiment of an example grooved pipe element;

FIG. 10 is a side view of a third embodiment of an example grooved pipe element;

FIG. 11 is an isometric view of an example adapter coupling shown with an example grooved pipe element ready to be joined;

FIG. 12 is an example partial longitudinal sectional view showing the adapter coupling and grooved pipe element taken along section 12,13-12,13 of FIG. 11;

FIG. 13 is a close up partial longitudinal section view showing the adapter coupling and the grooved pipe element taken along section 12,13-12,13 of FIG. 11;

FIG. 14 is an isometric view of the adapter coupling of FIG. 11 assembled to the example grooved pipe element;

FIG. 15 is an example partial longitudinal sectional view of the adapter coupling and grooved pipe element of FIG. 14, taken along section 15-17-15-17 of FIG. 14, showing the groove and key in a first tolerance condition;

FIG. 16 is an example partial longitudinal sectional view of the adapter coupling and grooved pipe element of FIG. 14, taken along section 15-17-15-17 of FIG. 14, showing the groove and key in a second tolerance condition;

FIG. 17 is an example partial longitudinal sectional view of the adapter coupling and grooved pipe element of FIG. 14, taken along section 15-17-15-17 of FIG. 14, showing a location where an undulatory section and swell are present;

FIG. 18 is an isometric view of the connection shown in FIG. 14 being joined to a flanged pipe element;

FIG. 19 is a magnified view of area 19 shown in FIG. 1; and

FIG. 20 is an example partial longitudinal sectional view of a grooved pipe element showing an undulatory section and swell as disclosed herein;

FIG. 21 shows a front view of an example pipe element according to the disclosure inserted end first into the central space of an example preassembled coupling according to the disclosure.

### DETAILED DESCRIPTION

The present disclosure can be understood more readily by reference to the accompanying detailed description, which includes examples, claims and drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a channel” can represent disclosure of embodiments in which only a single channel is provided, and unless the context dictates otherwise, can also represent disclosure of embodiments in which a plurality of such channels are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each (e.g., A and B, A and C, B and C, or A, B, and C).

As used herein “pipe” or “pipe element” is intended to mean any fluid pipe-like component including, but not limited to, pipe stock, pipe fittings such as elbows, caps and tees as well as fluid control components such as valves, reducers, strainers, restrictors, pressure regulators and the like. When a feature is described herein with respect to a “pipe” or a “pipe element,” it is understood that such description represents disclosure of that feature with respect to a specific form of “pipe” or “pipe element” as indicated above. For example, unless otherwise indicated, description of a feature with respect to a “pipe element” is intended to provide disclosure of a pipe fitting having the described feature.

As used herein, when referencing the point or region where two surfaces or features come together, the term “transition,” “transition region,” or “transitions” means a change from one surface or portion to another surface or portion via practical geometric forms such as arcs, fillets, chamfers, and other more generalized concave or convex features, inflections, or blends between the surfaces or features, it being understood that perfectly flat surfaces or sharp corners may not be practical and in many cases undesirable. The term “transition,” “transition region,” or “transitions” may comprise edge portions at either or both ends of surfaces or features described herein.

As used herein, the term “contiguous” means that two surfaces are connected, either directly or through a transition region. Two contiguous surfaces may share a common edge or boundary, or may be connected by a transition region therebetween. As described herein, the transition region may comprise a radiused surface, a chamfered surface, a fillet, or other transitional geometry connecting the two surfaces. For example, a first surface and a second surface that are contiguous may meet at an apparently sharp edge, or may be connected by a curved or radiused transition region extending between the first surface and the second surface. In some aspects, a transition region connecting two contiguous surfaces may have a length or peripheral dimension that is less than a length or peripheral dimension of either of the two surfaces being connected. In some aspects, and without limitation, a transition region connecting two contiguous surfaces may have a length or peripheral dimension of less than about 10 mm, less than about 5 mm, less than about 3 mm, or less than about 1 mm. These dimensions are provided by way of example only and are not intended to limit the scope of the term “contiguous” or the dimensions of any transition region. The term “contiguous” does not require that the two surfaces be coplanar or tangent to one another.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree of the stated position or orientation.

The word “or” as used herein means any one member of a particular list and, in alternative embodiments, unless context dictates otherwise, can include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the device, systems, and associated methods can be implemented and used without employing these specific details. Indeed, the device, systems, and associated methods can be placed into practice by modifying the illustrated device, systems, and associated methods and may be used in conjunction with any other apparatus and techniques conventionally used in the industry.

### Overview

Adapter couplings for joining flanged pipe elements to grooved pipe elements have traditionally required manual assembly of multiple separate components around the pipe, which can be time-consuming and may risk damage to the gasket during assembly. Additionally, the need to maintain industry-standard bolt hole patterns while also achieving sufficient grip on the grooved pipe element has often resulted in connections with reduced rigidity, particularly reduced torsional rigidity.

The adapter coupling described herein addresses these challenges by providing a configuration in which segments are attached to one another end to end surrounding a central space, with a gasket positioned in a channel. The adapter coupling is provided in a preassembled state in which the gasket supports the segments in spaced apart relation. This preassembled configuration allows the grooved pipe element to be inserted directly into the central space without disassembly of the coupling components. In some optional aspects, the adapter coupling may further comprise keys having tapered keywalls that engage with correspondingly shaped groove sidewalls on the grooved pipe element. As the segments are drawn toward one another via adjustable attachment members, the keys wedge into the groove, promoting a firm connection and increased joint rigidity. In some optional aspects, the keys may comprise undulatory sections and swells that provide localized forceful engagement with the groove, further enhancing rigidity and accommodating manufacturing tolerances.

### Adapter Couplings

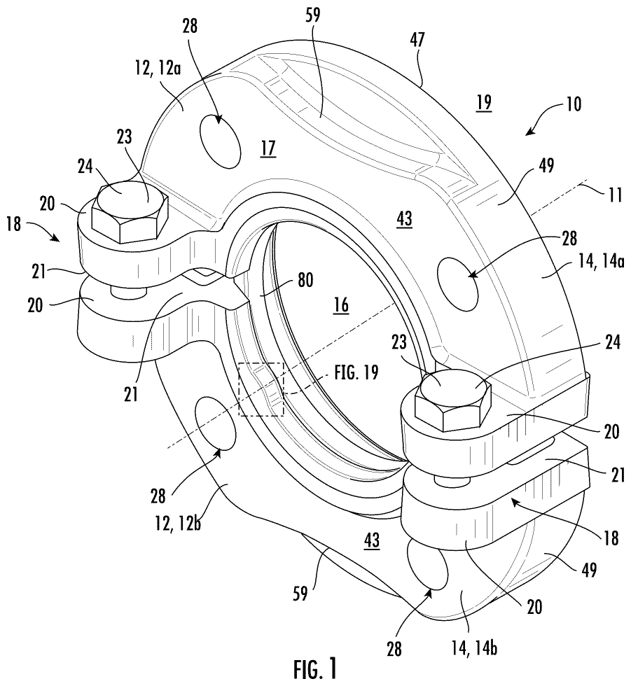

FIGS. 1-3 show an example embodiment of an adapter coupling 10 for joining a flanged pipe element to a grooved pipe element. Adapter coupling 10 may also be described as having a pipe side 17, to which a grooved pipe will be inserted and joined, and a flange side 19, to which the flanged pipe element will subsequently be joined. Coupling 10 comprises a plurality of segments 12, in this example, a first segment 12a and a second segment 12b configured to attached to one another end to end and configured to surround a central space 16 and longitudinal axis 11. The longitudinal axis 11 may be a central axis of the coupling 10 when the plurality of segments 12 are attached end to end. FIGS. 1-3 show the example coupling 10 in a preassembled state. In the preassembled state, the plurality of segments 12 are supported in spaced relation while attached to one another to allow insertion of the pipe element into the central space 16. Although coupling 10 is shown with two segments 12a, 12b, it is understood that coupling 10 may comprise more than two segments. For example, the coupling 10 may comprise three or four segments. In such embodiments, each of the three or four segments extend over a shorter arc length than a two segment coupling of the same diameter, such that the three or four segments surround the central space (e.g., by forming a loop about the central space), otherwise they are joined to one another in a similar manner as segments 12, and operate in all relevant respects the same as segments 12 shown herein. Segments 12 may be advantageously formed of cast ductile iron, although other materials may also be used.

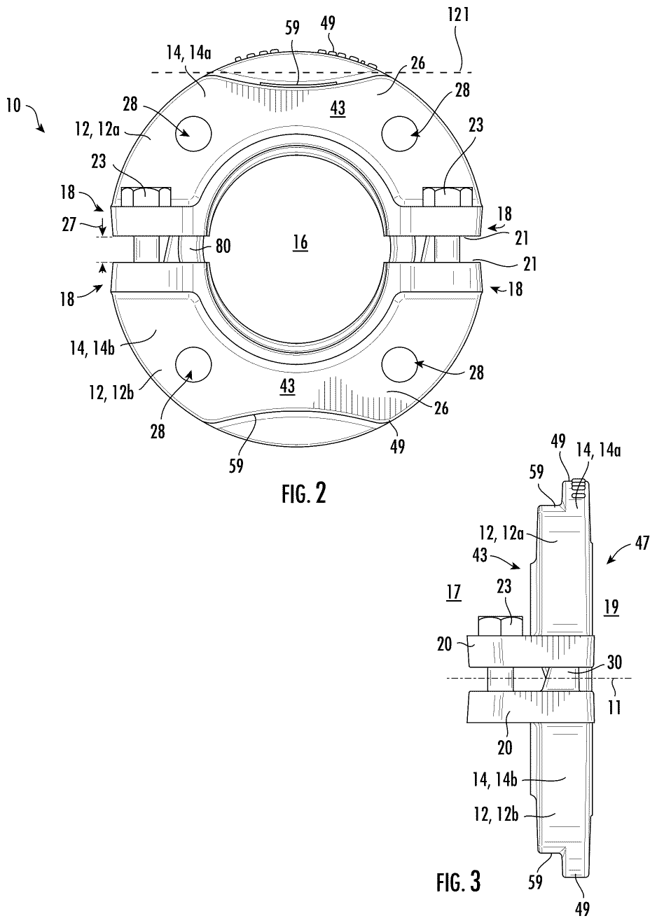

Each segment 12 comprises an outwardly extending flange body 14. The first segment 12a comprises an outwardly extending first flange body 14a and the second segment 12b comprises an outwardly extending second flange body 14b. The segments 12 each comprise an outwardly extending flange body 14a and 14b, respectively. When the plurality of segments 12 are attached end to end, the flange bodies 14a, 14b may extend radially outward from the central space 16 and the longitudinal axis 11. Each flange body 14 may comprise a pipe-facing side portion 43. The pipe-facing side portion 43 may extend parallel or substantially parallel (for example within 10° of parallel) to a plane perpendicular to the longitudinal axis 11. Each flange body 14 may comprise a flange-facing side portion 47. The flange-facing side portion 47 may extend parallel or substantially parallel (for example within 10° of parallel) to a plane perpendicular to the longitudinal axis 11. Each flange body 14 may comprise an outermost surface 49 facing away or substantially away from the central space 16. The outermost surface 49 may be contiguous with the pipe-facing side portion 43 and the flange-facing side portion 47. The outermost surface 49 may extend between the pipe-facing side portion 43 and the flange-facing side portion 47. Optionally, a portion 59 of the outermost surface 49 of the flange body 14a, 14b may be recessed (e.g., recessed relative to adjoining portions of the outermost surface 49 of the flange body). The recessed portion 59 may be located on the pipe side 17 and extend from the pipe-facing side portion 43 into the flange body 14a, 14b. Optionally, the recessed portion 59 may have a width that is approximately half the width of the flange body 14, wherein respective widths are measured along axes that are parallel or substantially parallel (for example within 10° of parallel) to the longitudinal axis 11. As shown in FIG. 2, the recessed portion 59 may be shaped such that at least two points upon recessed portion 59 form a line 121 that is perpendicular to longitudinal axis 11 and parallel to facing surfaces 21. The recessed portion 59 may have a radially outermost surface that is concave such that the lowest part of the curve is about midway between the ends of the recessed portion. The recessed portion 59 may extend about the center third of the flange body 14a, 14b.

Attachment of the segments 12a and 12b is effected via attachment members 18 positioned at each end of each segment. In this example, attachment members 18 comprise projections 20 that extend from the ends of the segments, the projections 20 having openings 22 that receive a fastener 23, such as bolt 24. As shown in FIG. 3, projections 20 extend from respective segments 12a and 12b in a direction parallel or substantially parallel (for example within 10° of parallel) to longitudinal axis 11, thereby reducing the overall dimensional envelope of the adapter coupling in a direction perpendicular to the longitudinal axis 11. The projections 20 extend from the pipe-facing side portion 43 of the flange body 14. The projections 20 may extend from the pipe-facing side portion 43 of the flange body 14 in a direction parallel or substantially parallel (for example within 10° of parallel) to the longitudinal axis 11. Optionally, the projections 20 extend perpendicularly or substantially perpendicularly (for example within 10° of perpendicular) to the pipe-facing side portion 43. Each opening 22 (see FIG. 5) configured to receive a fastener 23 may be positioned between the central space 16 and the outermost surface 49 of the respective flange body 14. Each opening 22 may be positioned between the central space 16 and the outermost surface 49 of the respective flange body 14 when viewed from the pipe side 17 of the coupling 10, wherein in the pipe side 17 view, the pipe-facing side portion 43 of the flange body 14 is visible and the flange-facing side portion 47 is not visible. As shown in FIG. 1, bolts 24 may be threaded directly into openings 22 of segment 12b, which may be threaded to receive respective bolts 24. Similarly, openings 22 of segment 12a may be through-holes such that tightening of the bolts 24 draws segments 12a and 12b toward one another and toward central space 16. Alternatively, openings 22 on both the first segment 12a and the second segment 12b may be through-holes, and nuts may be used with bolts 24 to effect assembly of the adapter coupling 10.

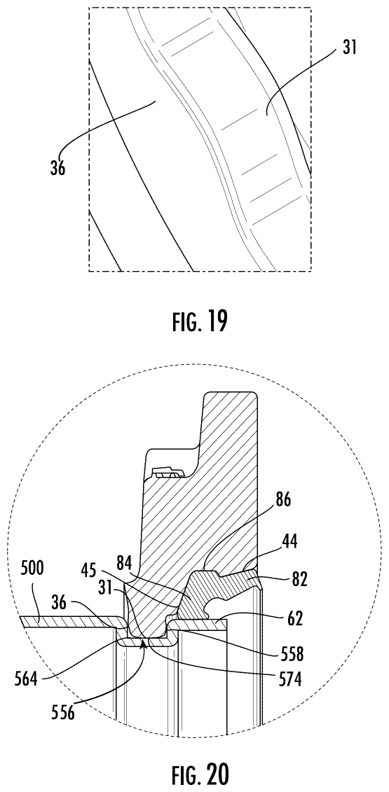

Each segment 12 may comprise at least one flange hole 28. Each flange hole 28 is configured to receive a fastener to couple the adapter coupling 10 to a flanged pipe element (see FIG. 18). Each flange hole 28 may extend through the flange body 14. Each flange hole 28 may extend from the pipe-facing side portion 43 to the flange-facing side portion 47. The flange holes 28 may be located according to a predetermined pattern to match the holes in the flanged pipe element to be coupled to the adapter coupling 10. The predetermined pattern may be an industry-standard bolt hole pattern. The predetermined pattern may be defined with respect to the adapter coupling 10 in the tightened condition rather than with respect to an individual segment 12.

Each segment 12 may comprise facing surfaces 21 at each end of the respective segment. When the plurality of segments 12 are attached end to end, the facing surfaces 21 on the first segment 12a are in facing relation with the facing surfaces 21 on the second segment 12b and are drawn toward one another respectively as the fasteners 23 are tightened. Optionally, the tightening process may be complete and the coupling may be in a tightened configuration when facing surfaces 21 come into contact with one another. The facing surfaces 21 may be sized such that when the facing surfaces 21 on the first segment 12a contact the facing surfaces 21 on the second segment 12b, the flange holes 28 are positioned in the predetermined pattern. Contact between the facing surfaces 21 may ensure that the flange holes 28 are in the correct location with respect to the entire adapter coupling 10. In this manner, the location of the facing surfaces 21 relative to the flange holes 28 determines the final position of the flange holes 28 when the adapter coupling 10 is in the tightened configuration. Each projection 20 may extend from a respective facing surface 21 at the end of the segment in a direction parallel or substantially parallel (for example within 10° of parallel) to the longitudinal axis 11.

As shown in FIG. 2, adapter coupling 10 further comprises a ring gasket 80. Gasket 80 may be made of an elastomeric or other material capable of providing a seal. Gasket 80 surrounds central space 16 and is lodged between segments 12a and 12b. Gasket 80 may have sufficient material or structural stiffness to support the segments in spaced apart relation shown by gap 27 such that a pipe element (not shown) may pass into the central space 16 in order to be joined by the adapter coupling 10.

### Grooved Pipe Elements

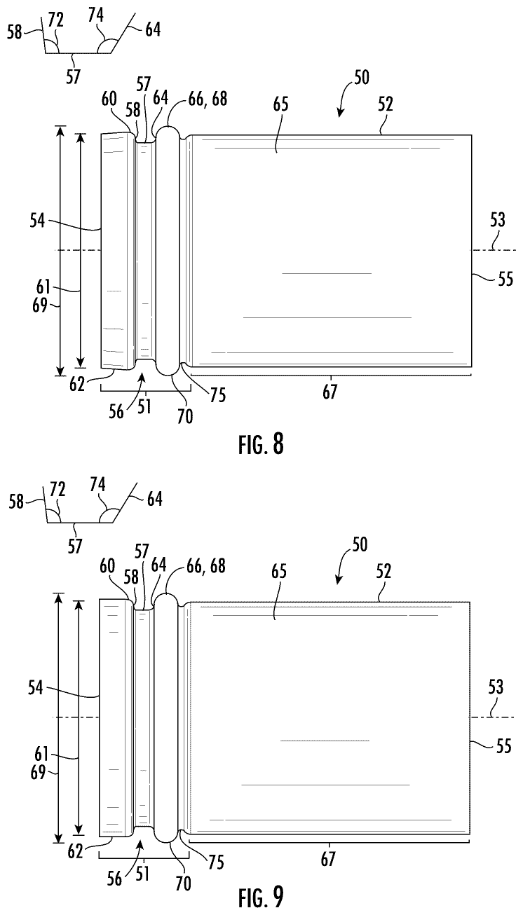

An example grooved pipe element 50 to be joined by adapter coupling 10 to a flanged pipe element is shown in FIG. 8. Grooved pipe element 50 comprises a sidewall 65 surrounding pipe axis 53 and defining a bore 63 (shown in FIGS. 11 and 12). The pipe axis 53 may be a central axis of the pipe element 50. The sidewall 65 comprises an outer surface 52, a first end 54, and a second end 55. The features of the sidewall 65, including the groove and bead described herein may be understood with reference to a cross-sectional plane including the pipe axis 53. As used herein, the outer surface 52 refers to the outward-facing surface of the sidewall 65 and includes all portions of the outward-facing surface regardless of the local geometry. The outer surface 52 includes surfaces within the groove, surfaces of the bead, surfaces of the tubular portion, and any other outward-facing surfaces of the sidewall 65. For example, the floor surface and side surfaces of the groove are portions of the outer surface 52, even though these surfaces may be positioned at a smaller radius than other portions of the outer surface 52. Similarly, the summit of the bead is a portion of the outer surface 52, even though the summit may be positioned at a larger radius than other portions of the outer surface 52. Radii of features of the outer surface 52 described herein are measured from the pipe axis 53.

Grooved pipe element 50 may be a thin wall pipe as understood in the industry, e.g., pipe that has a thinner wall than standard weight, Schedule 40 pipe, such as Schedule 10 pipe as of the date of filing. The grooved pipe element 50 may be made of any conventional piping material, or other suitable materials, including malleable materials such as ferrous and nonferrous metals and polymers. Optionally, the grooved pipe element 50 may be made of stainless steel.

The grooved pipe element 50 comprises an endform portion 51 adjacent to (optionally, immediately adjacent to) or contiguous with the first end, and the endform portion comprises a groove 56. The pipe element 50 may also comprise a balance 67 extending from the endform portion towards second end 55. The endform portion 51 is the portion of grooved pipe element 50 which is shaped and configured in order to be joined via groove 56. Similarly, balance 67 may be the remaining portion of the grooved pipe element which may comprise any of the configurations of grooved pipe elements at second end 55. For example, an exemplary grooved pipe element 50 comprising pipe stock may comprise endform 51 adjacent to (optionally, immediately adjacent to) or contiguous with first end 54 and balance portion 67 comprising the balance of the pipe stock terminating at second end 55 which could be a cutoff end, a threaded end, another endform 51 (to join the other end of the pipe element), and the like. As another example, a grooved pipe element 50 comprising a valve may comprise endform 51 adjacent to (optionally, immediately adjacent to) or contiguous with first end 54 and balance portion 67 extending toward second end 55 comprising a valve body.

Endform 51 comprises a groove 56 defined by the outer surface 52. The groove 56 comprises a floor 57 and first and second groove side surfaces. In the exemplary aspects represented in the drawings, the first and second groove side surfaces comprise a front sidewall 58 extending radially outwardly from the proximate end of floor 57 and a back sidewall 64 extending radially outwardly from the distal end of floor 57, wherein the first sidewall 58 faces the back sidewall 64. As used herein, “proximate” means closer to first end 54, and “distal” means farther from first end 54 (e.g. closer to second end 55). The front sidewall 58 is positioned between the first end 54 and the back sidewall 64. The front sidewall 58 and back sidewall 64 may include transitions at either or both of the ends of the sidewalls 58, 64. The front sidewall 58 and back sidewall 64 may each be planar, concave, convex, or combinations thereof. For example, the front sidewall 58 may have an S-shaped profile in a cross-sectional plane including the pipe axis 53. Optionally, a transition region may be provided between the S-shaped profile and floor surface 57. As shown, floor 57 may be generally cylindrical (i.e. where the portion of outer surface 52 that comprises floor 57 is within 5° of parallel with pipe axis 53). Front sidewall 58 extends radially outwardly from the floor 57 at a generally obtuse first angle 72, i.e, the included angle between the floor and a portion of the front sidewall is 90° or greater. When the front sidewall 58 and/or the back sidewall 64 is non-planar, the first angle 72 and/or the second angle 74 (described herein) may be measured relative to a line extending between the endpoints of the respective surface in a cross-sectional plane including the pipe axis 53. Optionally, where there is a transition between surfaces, an endpoint of one of the surfaces may be taken as the midpoint of the transition between the surfaces. For example, if there is a transition (for example, a fillet) between the floor surface 57 and the back sidewall 64, an endpoint of the back sidewall 64 is the midpoint of the transition between the floor surface 57 and the back sidewall 64. The first end 60 may be a summit having a diameter 61.

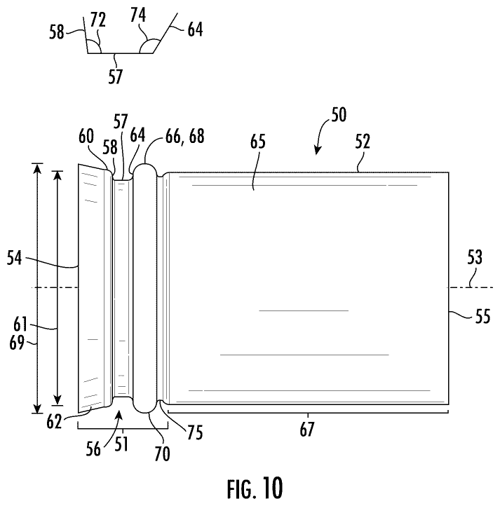

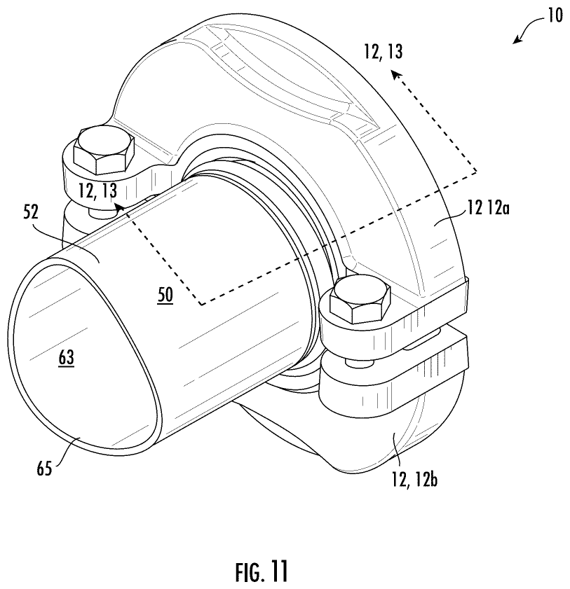

As shown in FIGS. 8-10, the endform 51 may further comprise a sealing surface 62 positioned between the front sidewall 58 and the first end 54 of the pipe element 50. The sealing surface 62 may extend from the front sidewall 58 (e.g. the first end 60 of the front sidewall 58) to the first end 54 of the pipe element 50. Optionally, the sealing surface 62 may be contiguous with the front sidewall 58, which can optionally have an S-shaped profile as further disclosed herein. As shown in FIG. 8, the sealing surface 62 may optionally be frustoconical such that a radius of the sealing surface 62 measured from the pipe axis 53 at a first point may be less than a radius of the sealing surface 62 measured from the pipe axis 53 at a second point, wherein the first point is closer to the first end 54 of the pipe element 50 than the second point to the first end 54 of the pipe element 50. As shown in FIG. 8, where the sealing surface 62 is frustoconical such that the sealing surface 62 tapers inwardly from the front sidewall 58 towards the end 54 of the pipe element 50, the first end 60 of the first groove side surface 64 may be a summit. The sealing surface 62 may be positioned between the summit and the end 54 of the pipe element 50. The sealing surface 62 may extend from the summit to the end 54 of the pipe element 50. Optionally, as shown in FIG. 10, a radius of the sealing surface 62 measured from the pipe axis 53 at a first point may be larger than a radius of the sealing surface 62 measured from the pipe axis 53 at a second point, wherein the first point is closer to the first end 54 of the pipe element 50 than the second point to the first end 54 of the pipe element 50. In an alternative embodiment as shown in FIG. 9, the sealing surface 62 may be cylindrical or substantially cylindrical.

The geometry of the sealing surface 62 may be influenced by the roll forming process used to form the endform 51 and by the tolerances of the pipe element 50. The roll forming process may be configured to position the floor surface 57 of the groove 56 at a predetermined radius to interact appropriately with the arcuate projection of the coupling 10. When the pipe element 50 has a diameter on the smaller side of the tolerance range, the roll forming process may drive the floor surface 57 to the predetermined radius, and there may be more clearance between the pipe element 50 and the roller surface that forms the first end 54 of the pipe element 50. In this case, the sealing surface 62 may flare or trumpet outwardly such that the sealing surface 62 has a larger radius at a point closer to the first end 54 than at a point further from the first end 54. When the pipe element 50 has a diameter on the larger side of the tolerance range, the sealing surface 62 may taper inwardly such that the sealing surface 62 has a smaller radius at a point closer to the first end 54 than at a point further from the first end 54. When the pipe element 50 has a diameter in the middle of the tolerance range, the sealing surface 62 may be cylindrical or substantially cylindrical. The coupling 10 and gasket 80 may be configured to seal against the sealing surface 62 regardless of whether the sealing surface 62 is frustoconical tapering inwardly, frustoconical tapering outwardly, cylindrical, or any combination thereof.

The back sidewall 64 may extend radially outwardly from floor 57 at a generally obtuse second angle 74. The back sidewall 64 may comprise a transition region where it extends from floor 57. Optionally, the back sidewall 64 may transition to bead 66 having a summit 68 which has a maximum diameter 69. Optionally, the maximum diameter 69 of summit 68 is greater than the diameter of outer surface 52 of balance 67. Distal of the summit 68, bead 66 may transition to slope 70 which decreases in diameter until the slope 70 transitions to balance 67. Optionally, and as shown in FIGS. 8-10, slope 70 may decrease in diameter until it is less than that of the proximate end of balance 67, terminating in indent 75. The distal portion of indent 75 may increase in diameter transitioning into balance 67.

The combination of generally obtuse angles 72 and 74 provides that groove 56 will be wedge-shaped, i.e., narrower at floor 57 than at a diameter greater than that of floor 57. As shown, first angle 72 is smaller than second angle 74, however, the angles can be the same, or second angle 74 may be greater than first angle 72. The maximum diameter 69 of the summit 68 may be the maximum diameter of at least a portion of the endform 51 extending from the first end 54 of the pipe element 50 to the summit 68. Optionally, maximum diameter 69 of summit 68 is greater than any other diameter of endform 51.

### Formation of Joints

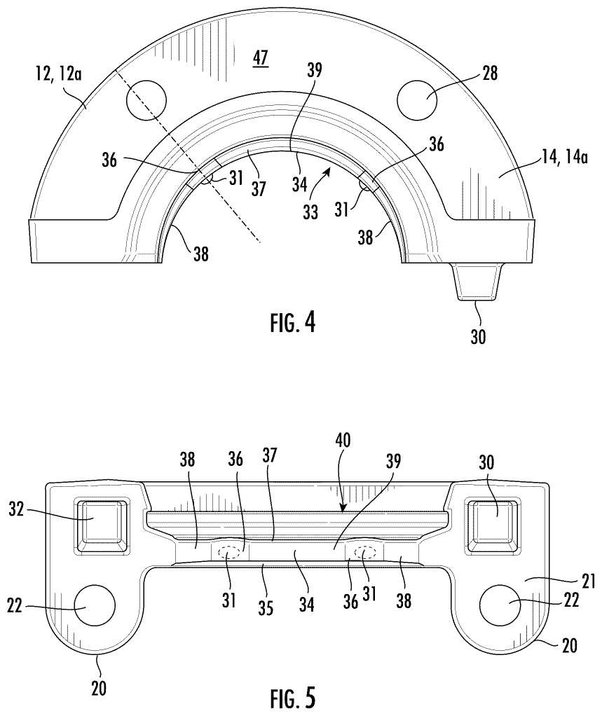

An example segment 12a of adapter coupling 10 is shown in FIGS. 4 and 5, and the description provided for segment 12a also equally applies to segment 12b, unless noted. Segment 12 further comprises flange holes 28, used for the fasteners that will connect adapter coupling 10 to the mating flanged pipe element (not shown). An arcuate projection or key 33, projects radially-inwardly from an inner portion of segment 12 for engaging with the groove of the grooved pipe element. As depicted, each side of the segment 12 may have a respective key 33. Each key 33 may comprise first and second keywalls (e.g., front keywall 35 and back keywall 37) and tip surface 39. Front keywall 35 faces the pipe side 17 of the adapter coupling 10. Back keywall 37 faces the flange side 19 of the adapter coupling 10. Front keywall 35 and back keywall 37 may generally taper towards one another such that key 33 may be generally wedge-shaped, i.e., wider the base of the key 33 than at tip surface 39, and are configured to engage the sidewalls of groove 56. Except where otherwise indicated, it is contemplated that a “taper” or a “tapered” portion/surface can refer to any gradual decrease or narrowing in width or diameter. Optionally, the “taper” or “tapered” portion/surface can be a consistent/constant taper moving along a given length (e.g., a taper at a fixed angle).

Each key 33 may be configured to wedge in the groove 56. The groove 56 may be configured to flex open to receive the key 33. Similarly, the bead 66 may be configured to flex closed as the groove 56 flexes open. The bead 66 may have a geometry that causes the bead 66 to act like a spring such that a base end of the back sidewall 64 is biased towards the first end 54 along the pipe axis 53. The bead 66 has a bead base width extending parallel or substantially parallel to the pipe axis 53. Optionally, in an initial condition before assembly, the bead base width is a first width, and in a tightened condition after assembly, the bead base width is a second width that is less than the first width. This spring-like action of the bead 66 facilitates wedging of the key 33 into the groove 56.

In some aspects, the keywalls 35, 37, and/or 39 of the key 33 and/or the side surfaces (sidewalls 64 and/or 58) of the groove 56 may experience localized deformation, including surface deformation, as each key 33 is wedged into the groove 56. It is expected that there will be varied combinations of flexing open of the groove 56 and localized deformation of the groove 56 as the key 33 is wedged into the groove 56 across varying tolerances of groove 56 and key 33.

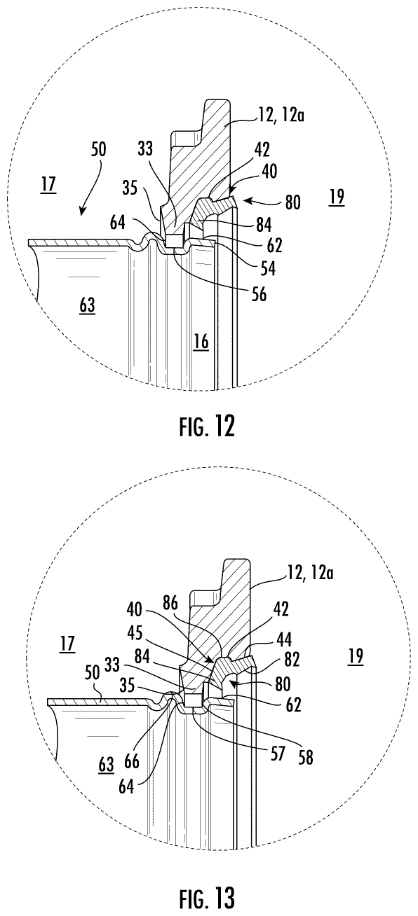

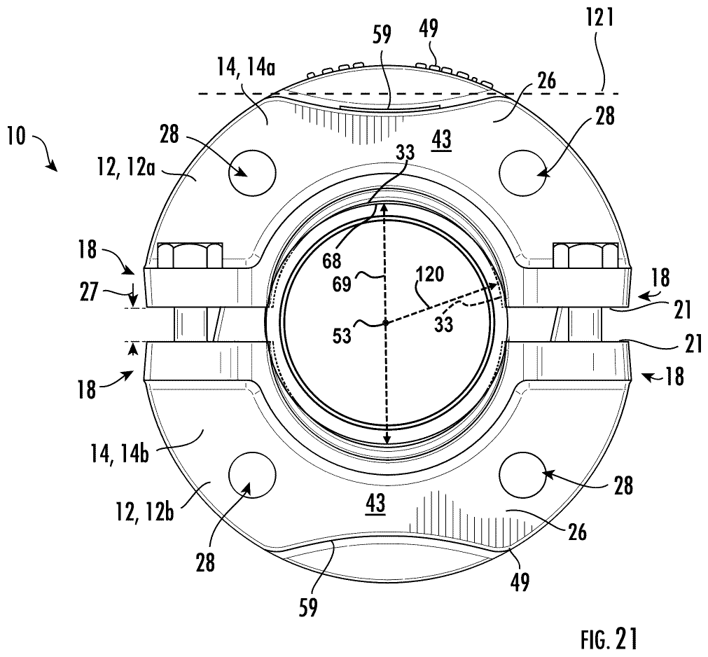

As shown in FIG. 13, in a cross-sectional plane including the longitudinal axis 53, the diameter 69 of the summit 68 of the bead 66 (see FIGS. 8-10) may be greater than twice a linear distance 120 (see FIG. 21) measured from the longitudinal axis 53 to at least a portion of the third mating surface 39 of the key 33, the linear distance 120 extending along an axis parallel or substantially parallel (for example within 5° of parallel) to the diameter 69 of the summit 68 of the bead 66 in a cross-sectional plane including the longitudinal axis 11, when the coupling 20 is in the preassembled state such that the coupling 20 engages the back sidewall 64 (second groove side surface) and the pipe element 50 is prevented from moving farther into the central space 16. As shown in FIG. 21 (gasket 57 and certain details of pipe element 22 are not shown for clarity), because the segments 12 are offset from the longitudinal axis 53 in the preassembled state, the bead 66 may only contact a portion of the coupling 20. In some embodiments, including as depicted in FIG. 13, the key 33 (in this example, the second mating surface 102 of the key 33) engages with bead 66. The geometry of the key 33 including the first keywall 35, and the geometry of the bead 66 and groove 56, including back sidewall 64 (second groove side surface), may be designed to force the pipe element 50 to move axially outward from the central space 16 as the key 33 slides radially inwardly towards the central space along a back sidewall 64 to align and facilitate the key 33 being received within the groove 56.

As shown in FIGS. 4 and 7, key 33 may be arcuate or be comprised of a series of arcuate sections that transition from one to another end to end. Key 33 may comprise relief sections 38 located near the ends of key 33, which sections relieve, or reduce, the radially inwards extension of the key 33 in those sections. The reduction in radially inwards extension of keys 33 provided by relief sections 38 assist in increasing the stability of adapter coupling 10 in the preassembled condition by providing clearance for the insertion of the grooved pipe element, allowing gap 27 to be smaller than it would be without the clearance provided by relief sections 38.

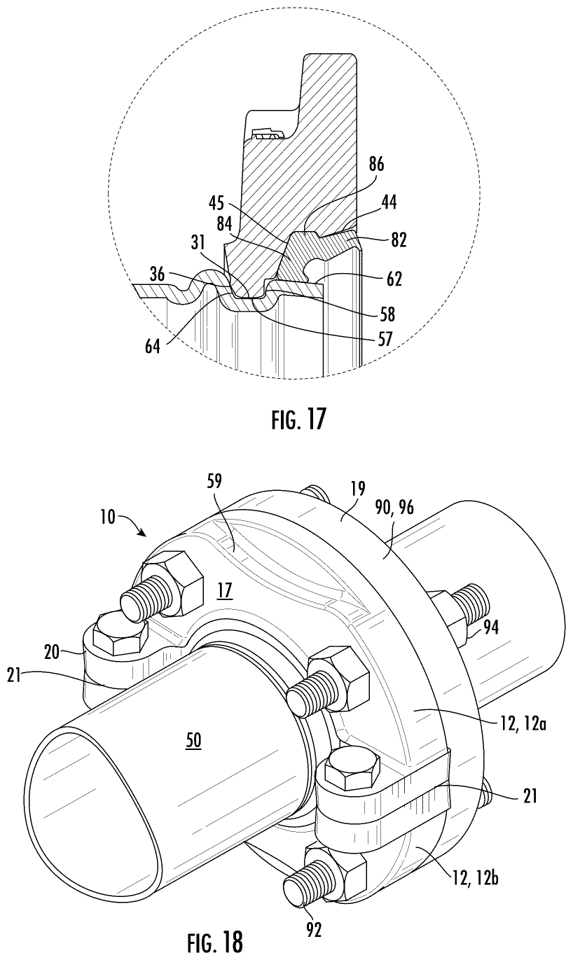

Similarly, front keywall 35, back keywall 37, and tip surface 39 may also comprise continuous surfaces or a series of surfaces that transition from one to another contiguously. As best seen in FIGS. 4-7, key 33 may comprise engagement section 34. The engagement section 34 may have a continuous surface that has a consistent amount of radially inward projection. In this embodiment, key 33 also comprises undulatory sections 36 located in between relief sections 38 and engagement section 34. Undulatory sections 36 may have a bulge extending from front keywall 35 in a generally axial direction, optionally including a corresponding increase in the axial width 29 of tip section 39, that, as explained below, provides localized forceful wedging engagement with the first and second side surfaces (sidewalls 58, 64) of the groove 56 in order to increase the rigidity of the joint (shown in FIGS. 17 and 20). In this example embodiment shown in FIGS. 4-7, two undulatory sections 36 are shown, however the number of undulatory sections 36 arrayed within key 33 may vary in number and is expected to increase as the size of the pipe elements to be joined increases, in order to provide additional rigidity on larger size pipe elements. Undulatory sections 36 may optionally comprise a bulge extending from front keywall 35, back keywall 37 (shown in FIGS. 4-7), or both front keywall 35 and back keywall 37, optionally including a concomitant increase in the axial width of tip section 39. Keys 33 may further comprise a swell 31 comprising a bulge that extends radially inwardly from tip surface 39 in order to locally increase the radially inward projection of keys 33. As shown in this example, swells 31 are located adjacent (optionally, immediately adjacent) or contiguous with undulatory sections 36, but the disclosure is not so limited and swells 31 may be located at any location on key 33. Similar to the bulges on undulatory sections 36, the bulges on swells 31 may create localized forceful engagement with the pipe groove in a manner that provides for increased rigidity after assembly, as described herein.

As shown in FIGS. 4-5, segment 12a may have an alignment boss 30, which extends from at least one end of the segment. The alignment boss 30 may extend from the facing surface 21 in a direction perpendicular or substantially perpendicular (for example within 10° of perpendicular) to the longitudinal axis 11. Optionally, the alignment boss 30 may extend from at least one of projections 20 toward segment 12b. Similarly, segment 12a may have recess 32 which extends within the segment. The recess 32 may extend within the facing surface 21. The recess 32 may extend within at least one projection 20. Boss 30 and recess 32 of segment 12a align with a similar, corresponding boss 30 and recess 32 of segment 12b, as seen in FIGS. 3, 6 and 7 (which are located mirrored about longitudinal axis 11) and cooperate to assist in the alignment of segments 12a and 12b as the segments 12a and 12b are drawn toward one another by the tightening of the fasteners 23. As can be best seen in FIGS. 1, 2, and 3, bosses 30 and respective recesses 32 may be partially engaged in the preassembled state in order to increase the stability of the adapter coupling 10 in that state. Bosses 30 and recesses 32 are mere examples of many features that could interlock or otherwise cooperate to assist in the stability and alignment of segments 12a and 12b.

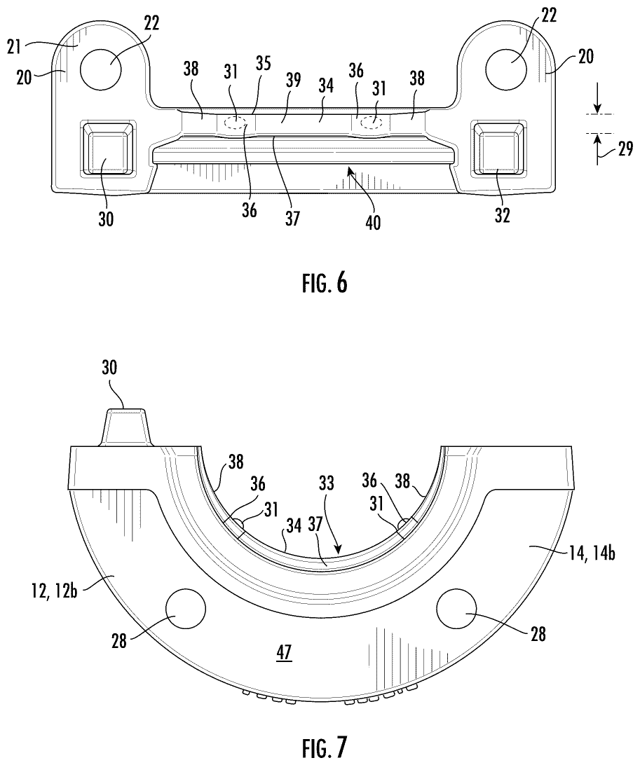

FIGS. 6 and 7 depict an example segment 12b of adapter coupling 10. Segment 12b is generally similar to segment 12a. However, the locations of boss 30 and recess 32 may be the mirror image of those on segment 12a to provide improved alignment and stability. Optionally, openings 22 of segment 12b may comprise tapped holes so that bolts 24 may be used without nuts, but the disclosure is not so limited.

As shown in FIGS. 5 and 6, segments 12a and 12b may each have a radially inwardly facing channel 40 for the receipt of the gasket 80. FIGS. 12 and 13 shows gasket 80 residing in channel 40. Channel 40 may comprise a generally concave retention pocket 42. Channel 40 may comprise a flange side wall 44 facing flange side 19. Channel 40 may comprise a pipe side wall 45 generally extending toward central space 16 and pipe side 17. Flange side wall 44 may be tapered radially outwardly in the direction toward flange side 19. Gasket 80 is generally ringlike. The gasket 80 may comprise a radially outwardly projecting retention lobe 86 which is configured to be received in retention pocket 42 of the segment, which may assist in retention of gasket 80 within adapter coupling 10 both during assembly of adapter coupling 10 to a pipe element and during the later assembly of a flanged pipe element to adapter coupling 10. Gasket 80 may comprise a flange side leg 82 adjacent (optionally, immediately adjacent) or contiguous with the flange side wall 44. Flange side leg 82 may engage flange side wall 44. The flange side leg 82 may generally extend toward the flange side 19. The gasket 80 may comprise a pipe side leg 84 adjacent (optionally, immediately adjacent) or contiguous with pipe side wall 45. Pipe side leg 84 may engage the pipe side wall 45. Pipe side leg 84 may generally extend towards the center space 16.

Optionally, adapter coupling 10 is provided in the preassembled form shown in FIG. 1, with segments 12a and 12b being separated from one another upon gasket 80 but connected to one another to surround said central space 16 (e.g., by forming a loop) by the action of fasteners 23 engaged with projections 20. Reception of the retention lobe 86 in retention pocket 42 helps ensure that the gasket 80 remains lodged in between the segments 12a, 12b and does not slip out, especially as the taper of flange side wall 44 may provide an opening to do so as the gasket 80 is compressed during assembly.

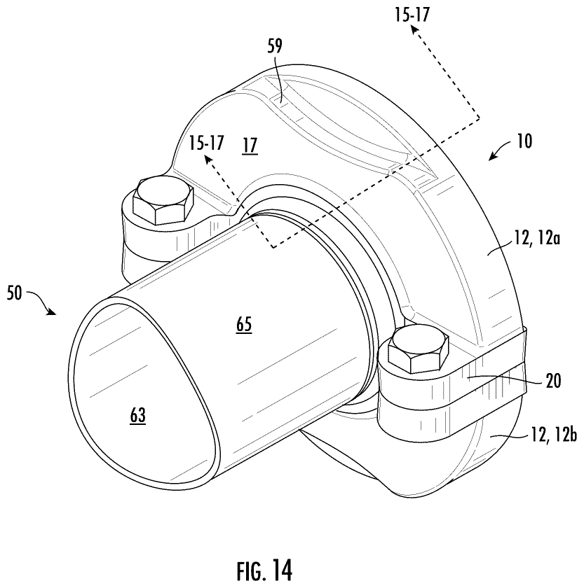

With reference to FIGS. 11-17, an example grooved pipe element 50 is inserted into the adapter coupling 10. Where the grooved pipe element comprises endform 51, having bead 66, bead 66 may contact front keywall 35, locating keys 33 over groove 56. Tightening of fasteners 23 may bring segments 12a, 12b toward one another. As the segments 12a, 12b are drawn together, bosses 30 may engage corresponding recesses 32 until facing surfaces 21 on segments 12a, 12b respectively come into contact. The plurality of segments 12a, 12b may be drawn towards one another from an initial condition (which, optionally, is the preassembled form) (shown in FIGS. 11-13) to a tightened condition (shown in FIGS. 14-17). As the attachment members 18 are adjusted to draw the segments to the tightened condition, the key 33 may wedge open the groove 56. In the initial condition, the first angle 72 is a first angle and the second angle 74 is a second angle. Optionally, in the tightened condition, the first angle 72 is a third angle and the second angle 74 is a fourth angle. The third angle is greater than the first angle and the fourth angle is greater than the second angle. Contact between facing surfaces 21 may be used to stage flange holes 28 on segments 12a and 12b into the appropriate industry standard location for later assembly to a flanged pipe element. During this process, gasket 80 may be compressed such that pipe side leg 84 engages sealing surface 62 of grooved pipe element 50. The interface between retention pocket 42 and retention lobe 86 may keep the gasket 80 stable and captured within adapter coupling.

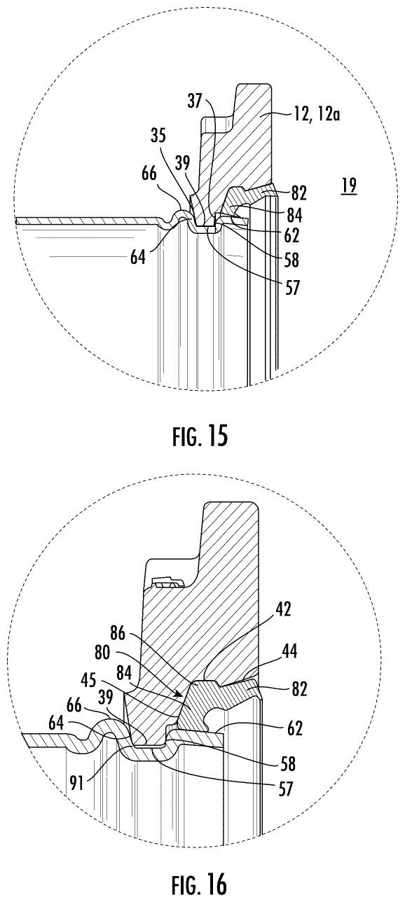

During this process, keys 33 also engage with groove 56. As shown in FIGS. 12 and 13, keys 33 may have a wedge-like shape due to the taper between front keywall 35 and back keywall 37. This wedge-like shape may be generally narrower at tip surface 39 than at a base of the key. Similarly, groove 56 generally describes a wedge-like shape due to the effect of angles 72 and 74 which may open away from each other, the wedge-like shape being narrower at floor 57 than at a location radially outward from floor 57. Tip surface 39 may have a width 29 (that may vary due to the presence of undulatory sections 36). Width 29 and the taper of front keywall 35 and back keywall 37 may be sized such that front and back keywalls 35,37 will contact the first and second groove side surfaces (front sidewall 58 and back sidewall 64) before tip surface 39 contacts floor 57, and before the coupling 10 reaches the tightened condition. In some cases, the tip surface 39 may be spaced from the floor 57 by a gap 91 in the tightened condition (shown in FIG. 16). In other cases, the tip surface 39 may contact the floor 57 in the tightened condition (shown in FIG. 15). In a cross section including the longitudinal and pipe axes 11, 53, the key 33 may have a larger cross-sectional area than a cross-sectional area of the space defined by the groove. This geometric relationship means that continued tightening of bolts 24 will cause keys 33 to forcefully wedge into groove 56 promoting a firm connection and a more rigid joint. Depending on the material and material thickness comprising grooved pipe element 50, the endform 51 may deform in response to this wedging effect. Such deformation may cause angles 72 and 74 to increase, and where pipe element 50 is made of malleable materials, including steel or stainless steel, the pipe element 50 may experience localized deformation, including surface deformation, as the key 33 is wedged into the groove 56, due to the compliant, elastic nature of those materials. The localized deformation may cause groove 56 to more firmly grip key 33. It is expected that there will be varied combinations of flexing open of the groove 56 and localized deformation of the groove 56 as the key 33 is wedged into the groove 60 across varying tolerances of groove 56 and key 33.

It is understood that in practical embodiments, manufacturing tolerances on the size of groove 56 and of keys 33 will affect the degree of forceful contact that can be achieved given that contact between facing surfaces 21 acts to limit the extent that segments 12a, 12b can be drawn toward one another (and therefore, the extent that keys 33 can be driven into groove 56). This may be partially addressed by sizing the key 33 and groove 56 in order to take into account those tolerances such that at an extreme, tip surface 39 will contact floor 57 (see FIG. 15 representing a first tolerance condition, wherein the groove 56 may be at an upper end of the tolerance range and the key 33 may be at the lower end of the tolerance range), but that in other cases, a gap 91 between tip surface 39 and floor 57 will remain, such that no premature contact of tip surface 39 with floor 57 can reduce the magnitude of the wedging action (see FIG. 16 representing a second tolerance condition, wherein the groove 56 may be at a lower end of the tolerange range and the key 33 may be at the upper end of the tolerance range). The effect of manufacturing tolerances may further be addressed by the undulatory surfaces 36 and swells 31. FIGS. 15-17 represent a partial section through the assembled adapter coupling 10 on a line 15-17 (see FIG. 14). Section line 15-17 may pass through key 33 at a location where an undulatory section 36 and swell 31 are also present (see FIG. 17). The bulge of undulatory section 36 extending from front keywall 35 makes earlier contact with front sidewall 58 than other portions of front keywall 35, and the bulge of swell 31 may make contact with floor 57 of groove 56 even while a gap 91 is present at portions of keys 33 which do not comprise swells 31. The localized contact of the bulges of undulatory sections 36 and swells 31 is even more forceful due to its concentrated nature and may result in localized deformation of pipe element 50 at those points of contact, increasing rigidity (especially torsional rigidity), and helping to accommodate manufacturing tolerances.

As shown in FIG. 18, after bolts 24 have been sufficiently tightened to join adapter coupling 10 to grooved pipe element 50, optionally, as indicated by contact between facing surfaces 21, the adapter coupling may be joined to flanged pipe element 90. Flanged pipe element 90 may comprise a radial flange 96 having a series of holes (not shown) for joining with a mating flange. Flange element 90 is therefore located adjacent (optionally, immediately adjacent) or contiguous with the flange side 19 of adapter coupling 10 and the holes in flange element 90 are aligned to flange holes 28. Suitable fasteners, such as studs 92 (as shown here) are passed through and secured with, for instance, nuts 94. Flange side leg 82 of gasket 80 is compressed against the inner surface of flange element 90 as studs 92 and nuts 94 are tightened, completing the joint between grooved pipe element 50 and flanged pipe element 90. Joining the flanged pipe element 90 to the adapter coupling 10 may comprise compressing the flange side leg 82 of the gasket 80 against an inner surface of the flanged pipe element 90.

While the pipe element 50 having endform 51 comprising a groove having a wedge-like shape has certain advantages when used with adapter coupling 10, it is anticipated that the wedging effect described herein, and optionally the use of the swells and undulatory portions of the keys that increase the effectiveness of the wedging effect, may be used with any form of grooved pipe element having sidewalls that can be engaged by the sidewalls of the keys. For example, as shown in FIG. 20, pipe element 500 is shown engaged with key 33 of adapter coupling 10. Pipe element 500 is similar to pipe element 50; however, front sidewall 558 and back sidewall 564 of groove 556 extend radially outwardly from the floor surface 574 at angles about 90° (meaning, within about 5° of 90°). Similarly, it is expected that the wedging effect described herein using the swells and undulatory projections with grooves having a generally wedge-like shape may also be used to promote rigidity in other grooved piping components known in the art, such as couplings.

A method of joining a flanged pipe element to a grooved pipe element using an adapter coupling 10 as disclosed herein may be performed as follows. The adapter coupling 10 may be provided in the preassembled state with the gasket 80 supporting the segments 12a, 12b in spaced apart relation sufficient to allow the grooved pipe element 50 to be inserted into the central space 16.

The grooved pipe element 50 is inserted into the central space 16 of the adapter coupling 10 in the preassembled state. Inserting the grooved pipe element 50 may comprise inserting the grooved pipe element 50 until the endform 51 contacts the front keywall 35. Where the endform 51 comprises the bead 66, and the groove 56 is positioned between the first end 54 of the grooved pipe element 50 and the bead 66, the bead 66 may contact the back keywall 37, locating the keys 33 axially with the groove 56.

The adjustable attachment members 18 are then adjusted to draw the plurality of segments 12a, 12b toward one another such that the back keywall 37 may engage the first groove side surface (front sidewall 58) and the front keywall 35 may engage the second groove side surface (back sidewall 64). Adjusting the adjustable attachment members 18 may cause the keys 33 to wedge into the groove 56. Where the front sidewall 58 is oriented at a first angle 72 relative to the floor 57 and the back sidewall 64 is oriented at a second angle 74 relative to the floor 57, adjusting the adjustable attachment members 18 may cause the first angle 72 to increase and the second angle 74 to increase. Adjusting the adjustable attachment members 18 may cause deformation of the endform 51.

Adjusting the adjustable attachment members 18 compresses the gasket 80 such that the pipe side leg 84 of the gasket 80 engages the sealing surface 62 of the endform 51.

Where the endform 51 comprises the bead 66, and the groove 56 is positioned between the first end 54 of the grooved pipe element 50 and the bead 66, adjusting the adjustable attachment members 18 may cause the bead 66 to flex closed as the groove 56 flexes open. The bead 66 may act like a spring to facilitate wedging of the key 33 into the groove 56.

The flanged pipe element 90 is then joined to the adapter coupling 10 by aligning holes in the flanged pipe element 90 with the flange holes 28 in the segments 12a, 12b and securing the adapter coupling to the flanged pipe element with fasteners, such as studs 92 and nuts 94. Joining the flanged pipe element 90 comprises compressing the flange side leg 82 of the gasket 80 against an inner surface of the flanged pipe element 90.

### CONCLUSION

It is expected that the adapter coupling described herein will address one or more of the challenges associated with joining flanged pipe elements to grooved pipe elements by providing one or more of the following features:
(1) By providing the adapter coupling in a preassembled state, the need to manually assemble multiple separate components around the pipe element is reduced, simplifying installation and reducing the risk of damage to the gasket during assembly;
(2) The wedging engagement between the tapered keywalls and the correspondingly shaped groove sidewalls promotes a firm connection with increased rigidity, including torsional rigidity;
(3) The use of facing surfaces that come into contact upon tightening ensures that the flange holes are positioned in the predetermined industry-standard pattern with respect to the entire adapter coupling;
(4) The projections extending in a direction parallel or generally parallel to the longitudinal axis minimizes the overall dimensional envelope of the adapter coupling in a direction perpendicular to the axis, reducing the profile of the coupling; and/or
(5) Additionally, the optional undulatory sections and swells on the keys provide localized forceful engagement with the groove, further enhancing rigidity and accommodating manufacturing tolerances across the range of pipe, groove, and adapter tolerances encountered in practical applications.

All of the embodiments of the claimed disclosure described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: An adapter coupling for joining a flanged pipe element to a grooved pipe element, said adapter coupling comprising:
a plurality of segments attached to one another end to end surrounding a central space, each of said segments comprising:
a flange body having a pipe-facing side portion and a flange-facing side portion;
a channel positioned within said flange body extending circumferentially therearound and facing said central space;
a gasket positioned in said channel;
a key positioned on said flange body, said key extending toward said central space; and
adjustable attachment members positioned at ends of said segments for attaching said segments to one another.

Aspect 2: The adapter coupling according to any of the preceding aspects, wherein each said key comprises:
a radially inwardmost tip surface extending along said key;
a first keywall extending from said flange body to said tip surface; and
a second keywall extending from said flange body to said tip surface,
wherein said first keywall and said second keywall are inclined towards one another, being closer together at said tip surface than at a base of said key.

Aspect 3: The adapter coupling according to aspect 2a, wherein at least one of said keywalls further comprises a bulge projecting from said keywall.

Aspect 4: The adapter coupling according to aspect 2 or aspect 3, wherein said tip surface further comprises a bulge projecting towards said central space.

Aspect 5: The adapter coupling according to any of aspects 2-3, wherein said key comprises an engagement section having a continuous surface that has a consistent amount of radially inward projection.

Aspect 6: The adapter coupling according to any of aspects 2-5, wherein said key comprises undulatory sections having a bulge extending from said first keywall in a generally axial direction.

Aspect 7: The adapter coupling according to aspect 6, wherein said undulatory sections have an increase in axial width of said tip surface.

Aspect 8: The adapter coupling according to any of the preceding aspects, wherein said key comprises relief sections located near ends of said key, said relief sections reducing a radially inward extension of said key.

Aspect 9: The adapter coupling according to any of the preceding aspects, wherein said channel comprises a concave retention pocket.

Aspect 10: The adapter coupling according to any of the preceding aspects, wherein said gasket comprises a retention lobe projecting from an outer surface of said gasket into said concave retention pocket.

Aspect 11: The adapter coupling according to any of the preceding aspects, wherein said gasket comprises a ring having a flange side leg and a pipe side leg.

Aspect 12: The adapter coupling according to aspect 11, wherein said flange side leg is adapted to engage an outer surface of said flanged pipe element and said pipe side leg is adapted to engage an outer surface of said grooved pipe element.

Aspect 13: The adapter coupling according to any of the preceding aspects, wherein said gasket has sufficient material or structural stiffness to support said segments in spaced apart relation such that said grooved pipe element may pass into said central space.

Aspect 14: The adapter coupling according to any of the preceding aspects, wherein said plurality of segments are attached to one another end to end in a preassembled state, wherein in said preassembled state, said plurality of segments are supported in spaced relation while attached to one another to allow insertion of said grooved pipe element into said central space.

Aspect 15: The adapter coupling according to any of the preceding aspects, wherein each of said segments comprises flange holes for fasteners to connect said adapter coupling to said flanged pipe element.

Aspect 16: The adapter coupling according to any of the preceding aspects, wherein said plurality of segments comprises a first segment and a second segment.

Aspect 17: The adapter coupling according to any of the preceding aspects, wherein said segments are formed of cast ductile iron.

Aspect 18: An adapter coupling for joining a flanged pipe element to a grooved pipe element, said adapter coupling comprising:
a plurality of segments attached to one another end to end surrounding a central space and a longitudinal axis, each of said segments comprising:
a flange body having a pipe-facing side portion and a flange-facing side portion, said flange body having facing surfaces at each end of said segments;
a key positioned on said flange body, said key extending toward said central space; and
projections extending from said pipe-facing side portion at each end of said segments, said projections extending in a direction parallel or generally parallel to said longitudinal axis, each of said projections comprising:
an opening configured to receive a fastener, said opening being positioned between said central space and an outermost surface of said flange body,
wherein said facing surfaces on respective ends of said segments are in facing relation with one another and are configured to be drawn toward one another as said fasteners are tightened.

Aspect 19: The adapter coupling according to aspect 18, wherein said projections extend from said flange body toward said pipe side.

Aspect 20: The adapter coupling according to aspect 18 or aspect 19, wherein said projections extending in said direction generally parallel to said longitudinal axis reduces an overall dimensional envelope of said adapter coupling in a direction perpendicular to said longitudinal axis.

Aspect 21: The adapter coupling according to any of aspects 18-20, wherein said opening of a projection on a first segment comprises a through-hole and said opening of a projection on a second segment comprises a tapped hole, such that a bolt may be threaded directly into said tapped hole of said second segment.

Aspect 22: The adapter coupling according to any of aspects 18-21, wherein said openings of said projections comprise through-holes, and wherein nuts are used with bolts to effect assembly of said adapter coupling.

Aspect 23: The adapter coupling according to any of aspects 18-22, wherein said segments are configured to be drawn toward one another and said central space upon tightening of said fasteners.

Aspect 24: The adapter coupling according to any of aspects 18-23, wherein said facing surface are configured to come into contact with one another upon tightening of fasteners received in said openings.

Aspect 25: The adapter coupling according to any of aspects 18-24, further comprising an alignment boss extending from one of said projections of a first segment toward a second segment.

Aspect 26: The adapter coupling according to any of aspects 18-25, further comprising a recess extending within another of said projections of said first segment, wherein said alignment boss and said recess of said first segment align with a corresponding recess and alignment boss on said second segment.

Aspect 27: The adapter coupling according to aspect 26, wherein said alignment boss and said recess are partially engaged in a preassembled state to increase stability of said adapter coupling.

Aspect 28: The adapter coupling according to any of aspects 18-27 wherein each said key comprises:
radially inwardmost tip surface extending along said key;
a first keywall extending from said flange body to said tip surface; and
a second keywall extending from said flange body to said tip surface,
wherein said first keywall and said second keywall are inclined towards one another, being closer together at said tip surface than at a base of said key.

Aspect 29: The adapter coupling according to aspect 28, wherein at least one of said keywalls further comprises a bulge projecting from said keywall.

Aspect 30: The adapter coupling according to aspect 28 or aspect 29, wherein said tip surface further comprises a bulge projecting towards said central space.

Aspect 31: The adapter coupling according to any of aspects 18-30, further comprising a channel positioned within said flange body extending circumferentially therearound and facing said central space.

Aspect 32: The adapter coupling according to aspect 31, further comprising a gasket positioned in said channel.

Aspect 33: The adapter coupling according to aspect 32, wherein said gasket has sufficient material or structural stiffness to support said segments in spaced apart relation such that said grooved pipe element may pass into said central space.

Aspect 34: The adapter coupling according to any of aspects 18-33, wherein each of said segments comprises flange holes for fasteners to connect said adapter coupling to said flanged pipe element.

Aspect 35: The adapter coupling according to aspect 34, wherein said facing surfaces are configured to stage said flange holes on said segments into an industry standard location for assembly to said flanged pipe element when said facing surfaces contact one another.

Aspect 36: The adapter coupling according to any aspects 18-35, wherein said plurality of segments comprises a first segment and a second segment.

Aspect 37: The adapter coupling according to any of aspects 18-36, wherein said plurality of segments are attached to one another end to end in a preassembled state, wherein in said preassembled state, said plurality of segments are supported in spaced apart relation by a gap while attached to one another to allow insertion of said grooved pipe element into said central space.

Aspect 38: The adapter coupling according to any of aspects 18-37, wherein said segments are formed of cast ductile iron.

Aspect 39: In combination, an adapter coupling and a grooved pipe element, said adapter coupling comprising:
a plurality of segments attached to one another end to end surrounding a central space, each of said segments comprising:
a flange body having a pipe-facing side portion and a flange-facing side portion;
a channel positioned within said flange body extending circumferentially therearound and facing said central space;
a gasket positioned in said channel;
a key positioned on said flange body, said key extending toward said central space, said key comprising:
a radially inwardmost tip surface extending along said key,
a first keywall extending from said flange body to said tip surface, and
a second keywall extending from said flange body to said tip surface,
wherein said first keywall and said second keywall are inclined towards one another, being closer together at said tip surface; and
adjustable attachment members positioned at ends of said segments for attaching said segments to one another;
said grooved pipe element comprising:
a sidewall surrounding a longitudinal axis and defining a bore, said sidewall having an outer surface;
an endform; and
a tubular portion connected to said endform, wherein said endform extends from an end of said grooved pipe element to said tubular portion, wherein said endform comprises:
a groove defined by said outer surface, said groove extending circumferentially around said bore, said groove comprising:
a first groove side surface (e.g., a front sidewall),
a second groove side surface (e.g., a back sidewall) facing said first groove side surface and in spaced apart relation from said first groove side surface along said longitudinal axis, wherein said first groove side surface is positioned between said end of said grooved pipe element and said second groove side surface, and
a floor surface contiguous with said first groove side surface and said second groove side surface,
wherein said keys are configured to engage with said groove such that said first keywall is configured to engage with said first groove side surface and said second keywall is configured to engage with said second groove side surface.

Aspect 40: The combination according to aspect 39, wherein said first groove side surface is oriented at a first groove side angle relative to said floor surface and said second groove side surface is oriented at a second groove side angle relative to said floor surface.

Aspect 41: The combination according to aspect 40, wherein said first groove side angle is an obtuse angle and said second groove side angle is an obtuse angle.

Aspect 42: The combination according to aspect 40 or aspect 41, wherein said second groove side angle is greater than said first groove side angle.

Aspect 43: The combination according to any of aspects 39-44, wherein said groove is configured to flex open to receive said key.

Aspect 44: The combination according to any of aspects 39-43, wherein said plurality of segments are configured to be drawn towards one another from an initial condition to a tightened condition, and wherein as said adjustable attachment members are adjusted to draw said segments to said tightened condition, said key wedges open said groove.

Aspect 45: The combination according to any of aspects 40-44, wherein:
in said initial condition, said first groove side angle is a first angle and said second groove side angle is a second angle;
in said tightened condition, said first groove side angle is a third angle and said second groove side angle is a fourth angle; and
said third angle is greater than said first angle and said fourth angle is greater than said second angle.

Aspect 46: The combination according to aspect 44 or aspect 45, wherein said endform deforms in response to said wedging.

Aspect 47: The combination according to any of aspects 39-46, wherein said grooved pipe element is made of a malleable material.

Aspect 48: The combination according to any of aspects 39-47, wherein said tip surface has a width, and wherein said width and a taper of said first keywall and said second keywall are sized such that said first keywall and said second keywall contact said first groove side surface and said second groove side surface before said tip surface contacts said floor surface.

Aspect 49: The combination according to any of aspects 39-48, wherein continued tightening of said adjustable attachment members causes said keys to forcefully wedge into said groove.

Aspect 50: The combination according to any of aspects 39-49, wherein said tip surface is spaced from said floor surface by a gap in a tightened condition.

Aspect 51: The combination according to any of aspects 39-49, wherein said tip surface contacts said floor surface in a tightened condition.

Aspect 52: The combination according to any of aspects 39-51, wherein at least one of said keywalls further comprises a bulge projecting from said keywall that engages with said groove.

Aspect 53: The combination according to aspect 52, wherein said bulge is configured to make earlier contact with a respective groove side surface than other portions of said keywall.

Aspect 54: The combination according to any of aspects 39-53, wherein said tip surface further comprises a bulge projecting towards said central space.

Aspect 55: The combination according to any of aspect 52-54, wherein said bulge of said tip surface contacts said floor surface while a gap is present at portions of said key which do not comprise said bulge.

Aspect 56: The combination according to any of aspects 39-55, wherein said endform further comprises a bead defined by said outer surface, said bead extending circumferentially around said bore, wherein said groove is positioned between said end of said grooved pipe element and said bead.

Aspect 57: The combination according to aspect 56, wherein said bead comprises a first bead side surface contiguous with said second groove side surface and a first summit.

Aspect 58: The combination according to aspect 57, wherein a radius of said first summit is greater than any other radius of said outer surface of said endform.

Aspect 59: The combination according to aspect 57 or aspect 58, wherein a radius of said first summit is greater than a distance measured from said longitudinal axis to said tip surface of said key when said adapter coupling is in a preassembled state.

Aspect 60: The combination according to any of aspects 56-59, wherein said bead contacts said second keywall, locating said keys over said groove.

Aspect 61: The combination according to any of aspects 56-60, wherein said bead is configured to flex closed as said groove flexes open.

Aspect 62: The combination according to any of aspects 56-61, wherein said bead has a geometry that causes said bead to act like a spring such that a base end of said first bead side surface is biased towards said end of said grooved pipe element along said longitudinal axis.

Aspect 63: The combination according to any of aspects 56-62, wherein said bead has a bead base width extending parallel or substantially parallel to said longitudinal axis, and wherein:
in an initial condition, said bead base width is a first width;
in a tightened condition, said bead base width is a second width; and
said second width is less than said first width.

Aspect 64: The combination according to any of aspects 39-63, wherein said first groove side surface terminates at a second summit, and wherein said endform further comprises a sealing surface positioned between said second summit and said end of said grooved pipe element.

Aspect 65: The combination according to aspect 64, wherein said gasket comprises a pipe side leg that engages said sealing surface when said gasket is compressed.

Aspect 66: The combination according to aspect 64 or aspect 65, wherein said sealing surface is frustoconical such that said sealing surface has a smaller radius at a point closer to said end of said grooved pipe element than at a point further from said end of said grooved pipe element.

Aspect 67: The combination according to any of aspects 39-66, wherein said grooved pipe element is a thin wall pipe.

Aspect 68: The combination according to any of aspects 39-67, wherein said grooved pipe element is a stainless steel pipe.

Aspect 69: The combination according to any of aspects 39-68, wherein said plurality of segments are attached to one another end to end in a preassembled state, wherein in said preassembled state, said plurality of segments are supported in spaced relation while attached to one another to allow insertion of said grooved pipe element into said central space.

Aspect 70: The combination according to any of aspects 39-69, wherein said channel comprises a concave retention pocket, and wherein said gasket comprises a retention lobe projecting into said concave retention pocket.

Aspect 71: The combination according to any of aspects 39-70, wherein said grooved pipe element comprises one of pipe stock, a pipe fitting, and a fluid control component.

Aspect 72: A method of joining a flanged pipe element to a grooved pipe element using an adapter coupling, said adapter coupling comprising a plurality of segments attached to one another end to end in a preassembled state surrounding a central space, each of said segments comprising a flange body, a channel positioned within said flange body, a gasket positioned in said channel, a key positioned on said flange body extending toward said central space, said key comprising a tip surface, a first keywall, and a second keywall, and adjustable attachment members positioned at ends of said segments; said grooved pipe element comprising a sidewall having an outer surface, an endform comprising a groove defined by said outer surface, said groove comprising a first groove side surface (e.g., a front sidewall), a second groove side surface (e.g., a back sidewall), and a floor surface; said method comprising:
inserting said grooved pipe element into said central space of said adapter coupling in said preassembled state;
adjusting said adjustable attachment members to draw said plurality of segments toward one another such that said first keywall engages said first groove side surface and said second keywall engages said second groove side surface; and
joining said flanged pipe element to said adapter coupling by aligning holes in said flanged pipe element with flange holes in said segments and securing with fasteners.

Aspect 73: The method according to aspect 72, wherein inserting said grooved pipe element comprises inserting said grooved pipe element until said endform contacts said second keywall.

Aspect 74: The method according to aspect 72 or aspect 73, wherein said endform comprises a bead, wherein said groove is positioned between said end of said pipe element and said bead, and wherein said bead contacts said second keywall, locating said keys axially with said groove.

Aspect 75: The method according to any of aspects 72-74, wherein adjusting said adjustable attachment members causes said keys to wedge into said groove.

Aspect 76: The method according to any of aspects 72-75, wherein said first groove side surface is oriented at a first groove side angle relative to said floor surface and said second groove side surface is oriented at a second groove side angle relative to said floor surface, and wherein adjusting said adjustable attachment members causes said first groove side angle to increase and said second groove side angle to increase.

Aspect 77: The method according to any of aspects 72-76, wherein adjusting said adjustable attachment members causes deformation of said endform.

Aspect 78: The method according to any of aspects 72-77, wherein said grooved pipe element is made of a malleable material.

Aspect 79: The method according to any of aspects 72-78, wherein adjusting said adjustable attachment members compresses said gasket such that a pipe side leg of said gasket engages a sealing surface of said endform.

Aspect 80: The method according to any of aspects 72-79, wherein joining said flanged pipe element comprises compressing a flange side leg of said gasket against an inner surface of said flanged pipe element.

Aspect 81: The method according to any of aspects 72-80, wherein said endform comprises a bead, wherein said groove is positioned between said end of said pipe element and said bead, and wherein adjusting said adjustable attachment members causes said bead to flex closed as said groove flexes open.

Aspect 82: The method according to aspect 81, wherein said bead acts like a spring to facilitate wedging of said key into said groove.

Aspect 83: The method according to any of aspects 72-82, wherein said grooved pipe element is a thin wall pipe.

Aspect 84: The method according to any of aspects 72-83, wherein said adapter coupling is provided in said preassembled state with said gasket supporting said segments in spaced apart relation sufficient to allow said grooved pipe element to be inserted into said central space.

Aspect 85: The method according to any of aspects 72-84, wherein said grooved pipe element comprises one of pipe stock, a pipe fitting, and a fluid control component.

What is claimed is:

1. An adapter coupling for joining a flanged pipe element to a grooved pipe element, said adapter coupling comprising:
a plurality of segments attached to one another end to end surrounding a central space, each of said segments comprising:
a flange body having a pipe-facing side portion and a flange-facing side portion;
a channel positioned within said flange body extending circumferentially therearound and facing said central space;
a gasket positioned in said channel;
a key positioned on said flange body, said key extending toward said central space; and
adjustable attachment members positioned at ends of said segments for attaching said segments to one another.

2. The adapter coupling according to claim 1, wherein each said key comprises:
a radially inwardmost tip surface extending along said key;
a first keywall extending from said flange body to said tip surface; and
a second keywall extending from said flange body to said tip surface,
wherein said first keywall and said second keywall are inclined towards one another, being closer together at said tip surface than at a base of said key.

3. The adapter coupling according to claim 2, wherein at least one of said keywalls further comprises a bulge projecting from said keywall.

4. The adapter coupling according to claim 2, wherein said tip surface further comprises a bulge projecting towards said central space.

5. The adapter coupling according to claim 3, wherein said tip surface further comprises a bulge projecting towards said central space.

6. The adapter coupling according to claim 2, wherein said key comprises an engagement section having a continuous surface that has a consistent amount of radially inward projection.

7. The adapter coupling according to claim 2, wherein said key comprises undulatory sections having a bulge extending from said first keywall in a generally axial direction.

8. The adapter coupling according to claim 7, wherein said undulatory sections have an increase in axial width of said tip surface.

9. The adapter coupling according to claim 2, wherein said key comprises relief sections located near ends of said key, said relief sections reducing a radially inward extension of said key.

10. The adapter coupling according to claim 1, wherein said channel comprises a concave retention pocket.

11. The adapter coupling according to claim 10, wherein said gasket comprises a retention lobe projecting from an outer surface of said gasket into said concave retention pocket.

12. The adapter coupling according to claim 1, wherein said gasket comprises a ring having a flange-facing side portion leg and a pipe-facing side portion leg.

13. The adapter coupling according to claim 12, wherein said flange-facing side portion leg is adapted to engage an outer surface of said flanged pipe element and said pipe-facing side portion leg is adapted to engage an outer surface of said grooved pipe element.

14. The adapter coupling according to claim 1, wherein said gasket has sufficient material or structural stiffness to support said segments in spaced apart relation such that said grooved pipe element may pass into said central space.

15. The adapter coupling according to claim 1, wherein said plurality of segments are attached to one another end to end in a preassembled state, wherein in said preassembled state, said plurality of segments are supported in spaced relation while attached to one another to allow insertion of said grooved pipe element into said central space.

16. The adapter coupling according to claim 1, wherein each of said segments comprises flange holes for fasteners to connect said adapter coupling to said flanged pipe element.

17. The adapter coupling according to claim 1, wherein said plurality of segments comprises a first segment and a second segment.

18. The adapter coupling according to claim 1, wherein said segments are formed of cast ductile iron.

19. An adapter coupling for joining a flanged pipe element to a grooved pipe element, said adapter coupling comprising:
a plurality of segments attached to one another end to end surrounding a central space and a longitudinal axis, each of said segments comprising:
a flange body having a pipe-facing side portion and a flange-facing side portion, said flange body having facing surfaces at each end of said segments;
a key positioned on said flange body, said key extending toward said central space; and
projections extending from said pipe-facing side portion at each end of said segments, said projections extending in a direction parallel or generally parallel to said longitudinal axis, each of said projections comprising:
an opening configured to receive a fastener, said opening being positioned between said central space and an outermost surface of said flange body,
wherein said facing surfaces on respective ends of said segments are in facing relation with one another and are configured to be drawn toward one another as said fasteners are tightened.

20. The adapter coupling according to claim 19, further comprising an alignment boss extending from one of said projections of a first segment toward a second segment.

21. The adapter coupling according to claim 20, further comprising a recess extending within another of said projections of said first segment, wherein said alignment boss and said recess of said first segment align with a corresponding recess and alignment boss on said second segment.

22. The adapter coupling according to claim 21, wherein said alignment boss and said recess are partially engaged in a preassembled state to increase stability of said adapter coupling.

23. The adapter coupling according to claim 19, wherein each said key comprises:
a radially inwardmost tip surface extending along said key;
a first keywall extending from said flange body to said tip surface; and
a second keywall extending from said flange body to said tip surface,
wherein said first keywall and said second keywall are inclined towards one another, being closer together at said tip surface than at a base of said key.

24. The adapter coupling according to claim 19, further comprising a channel positioned within said flange body extending circumferentially therearound and facing said central space.

25. The adapter coupling according to claim 24, further comprising a gasket positioned in said channel.

26. The adapter coupling according to claim 19, wherein each of said segments comprises flange holes for fasteners to connect said adapter coupling to said flanged pipe element.

27. The adapter coupling according to claim 19, wherein said plurality of segments are attached to one another end to end in a preassembled state, wherein in said preassembled state, said plurality of segments are supported in spaced apart relation by a gap while attached to one another to allow insertion of said grooved pipe element into said central space.

28. In combination, an adapter coupling and a grooved pipe element, said adapter coupling comprising:
a plurality of segments attached to one another end to end surrounding a central space, each of said segments comprising:
a flange body having a pipe-facing side portion and a flange-facing side portion;
a channel positioned within said flange body extending circumferentially therearound and facing said central space;
a gasket positioned in said channel;
a key positioned on said flange body, said key extending toward said central space, said key comprising:
a radially inwardmost tip surface extending along said key,
a first keywall extending from said flange body to said tip surface, and
a second keywall extending from said flange body to said tip surface,
wherein said first keywall and said second keywall are inclined towards one another, being closer together at said tip surface; and
adjustable attachment members positioned at ends of said segments for attaching said segments to one another;
said grooved pipe element comprising:
a sidewall surrounding a longitudinal axis and defining a bore, said sidewall having an outer surface;
an endform; and
a tubular portion connected to said endform, wherein said endform extends from an end of said grooved pipe element to said tubular portion, wherein said endform comprises:
a groove defined by said outer surface, said groove extending circumferentially around said bore, said groove comprising:
a first groove side surface,
a second groove side surface facing said first groove side surface and in spaced apart relation from said first groove side surface along said longitudinal axis, wherein said first groove side surface is positioned between said end of said grooved pipe element and said second groove side surface, and
a floor surface contiguous with said first groove side surface and said second groove side surface,
wherein said keys are configured to engage with said groove such that said first keywall is configured to engage with said first groove side surface and said second keywall is configured to engage with said second groove side surface.

29. The combination according to claim 28, wherein said first groove side surface is oriented at a first groove side angle relative to said floor surface and said second groove side surface is oriented at a second groove side angle relative to said floor surface.

30. The combination according to claim 29, wherein said first groove side angle is an obtuse angle and said second groove side angle is an obtuse angle.

31. The combination according to claim 29, wherein said second groove side angle is greater than said first groove side angle.

32. The combination according to claim 29, wherein said groove is configured to flex open to receive said key.

33. The combination according to claim 32, wherein said plurality of segments are configured to be drawn towards one another from an initial condition to a tightened condition, and wherein as said adjustable attachment members are adjusted to draw said segments to said tightened condition, said key wedges open said groove.

34. A method of joining a flanged pipe element to a grooved pipe element using an adapter coupling, said adapter coupling comprising a plurality of segments attached to one another end to end in a preassembled state surrounding a central space, each of said segments comprising a flange body, a channel positioned within said flange body, a gasket positioned in said channel, a key positioned on said flange body extending toward said central space, said key comprising a tip surface, a first keywall, and a second keywall, and adjustable attachment members positioned at ends of said segments; said grooved pipe element comprising a sidewall having an outer surface, an endform comprising a groove defined by said outer surface, said groove comprising a first groove side surface, a second groove side surface, and a floor surface; said method comprising:
inserting said grooved pipe element into said central space of said adapter coupling in said preassembled state;
adjusting said adjustable attachment members to draw said plurality of segments toward one another such that said first keywall engages said first groove side surface and said second keywall engages said second groove side surface; and
joining said flanged pipe element to said adapter coupling by aligning holes in said flanged pipe element with flange holes in said segments and securing with fasteners.
